(19) United States
(12) Patent Application Publication
(10) Pub. No.: US 2023/0358488 A1
(43) Pub. Date: Nov. 9, 2023

(54) HEAT EXCHANGER, MANUFACTURING METHOD THEREOF AND THERMAL MANAGEMENT SYSTEM

(71) Applicant: Hangzhou Sanhua Research Institute Co., Ltd., Hangzhou (CN)

(72) Inventors: Hai Huang, Hangzhou (CN); Ming Xue, Hangzhou (CN); Jianhua Tang, Hangzhou (CN); Shurui Yu, Hangzhou (CN); Linjie Huang, Hangzhou (CN)

(21) Appl. No.: 18/346,109

(22) Filed: Jun. 30, 2023

Related U.S. Application Data
(63) Continuation of application No. PCT/CN2021/142578, filed on Dec. 29, 2021.

(30) Foreign Application Priority Data
Jan. 8, 2021 (CN) 202110025330.6

(51) Int. Cl. F28F 21/08; F28F 19/06

(52) U.S. Cl. CPC F28F 21/089; F28F 19/06; F28F 2245/04

(57) ABSTRACT

A heat exchanger, a manufacturing method thereof and a thermal management system are provided. The heat exchanger includes a metal substrate having a fluid channel for circulating a heat exchange medium, and a coating layer coated on at least part of a surface of the metal substrate. The coating layer includes a rare earth conversion film containing a rare earth element-containing compound, and a hydrophobic film. The rare earth conversion coating film is arranged to directly cover at least part of a surface of the metal substrate of the heat exchanger, and at least part of the hydrophobic coating layer is further away from the metal substrate than the rare earth conversion film. The heat exchanger is provided with hydrophobicity by the coating layer, which facilitates the discharge of condensed water, and improves the corrosion resistance and prolongs the service life of the heat exchanger.

### INCORPORATION BY REFERENCE TO ANY PRIORITY

Any and all applications for which a foreign or domestic priority claim is identified in the Application Data Sheet as filed with the present application are hereby incorporated by reference under 37 CFR 1.57 and made a part of this specification.

### TECHNICAL FIELD

The present disclosure relates to the technical field of heat exchange and material, and in particular, to a heat exchanger, a manufacturing method thereof and a thermal management system.

### BACKGROUND

In the related art, moisture in the air may condense on a surface of a heat exchanger, which makes it is liable to form humid environment on the metal surface of the heat exchanger, and correspondingly, the metal surface of the heat exchanger is also prone to electrochemical corrosion. Some of improvement methods are to provide a chromium salt passivation coating layer on the surface of the heat exchanger, so as to delay corrosion to some extent. However, as a brazed connection technology is used to most of the heat exchangers, it is difficult to coat a chromite coating on a brazed part by reaction due to the presence of brazing flux, and thus, it is hard to coat at the brazed part, which may affect corrosion resistance of the heat exchanger. In addition, the chromium salt also affects the environment to some degree. Therefore, corrosion resistance of the heat exchanger in the related art needs to be improved.

### SUMMARY

In view of the above problems, the present disclosure provides a heat exchanger with good corrosion resistance. Correspondingly, the present disclosure further provides a manufacturing method of the heat exchanger, and a thermal management system including the heat exchanger.

According to an aspect of the present disclosure, a heat exchanger is provided, the heat exchanger includes a metal substrate, the metal substrate has a fluid channel for circulating a heat exchange medium, the heat exchanger further includes a coating layer, the coating layer includes a rare earth conversion coating layer and a hydrophobic coating layer; the rare earth conversion coating layer is arranged to cover at least part of a surface of the metal substrate, wherein the rare earth conversion coating layer includes a rare earth element-containing compound, and at least part of the hydrophobic coating layer is further away from the metal substrate than the rare earth conversion coating layer.

The heat exchanger of the present disclosure includes the rare earth conversion coating layer and the hydrophobic coating layer, wherein the rare earth conversion coating layer is used as an undercoat layer to cover at least part of the surface of the metal substrate of the heat exchanger, and the hydrophobic coating layer is further away from the metal substrate than the rare earth conversion coating layer. Therefore, the use of the hydrophobic coating layer can endow the surface of the heat exchanger with hydrophobicity, and the hydrophobic coating layer can increase a contact angle between water droplets in contact with the surface of the heat exchanger and the surface and reduce a contact area, so that the water droplets freeze slowly. In this way, the humid environment on the surface of the heat exchanger can be improved and the penetration of corrosive media into the metal substrate can be reduced. In addition, the rare earth conversion coating layer can block the redox reaction of the metal substrate, so that the corrosion resistance of the heat exchanger can be improved by cooperation of the rare earth conversion coating layer and the hydrophobic coating layer.

According to another aspect of the present disclosure, a manufacturing method of the heat exchanger is provided, the manufacturing method of the heat exchanger includes following steps:
providing a metal substrate, a rare earth conversion coating material and a hydrophobic coating material, wherein the metal substrate has at least one fluid channel for circulating a heat exchange medium;
applying the rare earth conversion coating material to at least part of a surface of the metal substrate to form a rare earth conversion coating layer, wherein the rare earth conversion coating material includes a rare earth element-containing compound; and
applying the hydrophobic coating material to at least part of a surface of the rare earth conversion coating layer, to form a hydrophobic coating layer.

In the manufacturing method of the heat exchanger according to the present disclosure, the rare earth conversion coating material is arranged to cover at least part of the surface of the metal substrate to form a rare earth conversion coating layer, which can block the redox reaction process of the metal substrate. The hydrophobic coating material is arranged to cover at least part of the surface of the rare earth conversion coating layer to form a hydrophobic coating material, which endows the surface of the heat exchanger with hydrophobicity. The hydrophobic coating layer can increase a contact angle between water droplets in contact with the surface of the heat exchanger and the surface and reduce a contact area, so that the water droplets freeze slowly. In this way, the humid environment on the surface of the heat exchanger can be improved and the penetration of corrosive media into the metal substrate can be reduced. The manufacturing method of the heat exchanger according to the present disclosure can improve the corrosion resistance of the heat exchanger.

According to a third aspect of the present disclosure, a thermal management system is provided, the thermal management system includes a compressor, a first heat exchanger, a throttling device and a second heat exchanger; when a refrigerant flows in the thermal management system, the refrigerant flows into the first heat exchanger from the compressor, and then flows into the throttling device after exchanging heat in the first heat exchanger, and then flows into the second heat exchanger and then flows into the compressor again after exchanging heat in the second heat exchanger, wherein at least one of the first heat exchanger and the second heat exchanger is the aforementioned heat exchanger.

In the thermal management system according to the present disclosure, at least one of the first heat exchanger and the second heat exchanger is the aforementioned heat exchanger, therefore, the heat exchanger has good corrosion resistance.

Additional aspects and advantages of the present disclosure will be set forth in part as follows, which will be obvious from the following description, or can be learned by practice of the present disclosure.

### BRIEF DESCRIPTION OF DRAWINGS

FIG. 1 is a schematic structural diagram of a heat exchanger according to an exemplary embodiment of the present disclosure;

FIG. 2 is a schematic cross-sectional view of a coating layer of a heat exchanger according to an exemplary embodiment of the present disclosure;

FIG. 3 is a schematic cross-sectional view of a fin of a heat exchanger according to an exemplary embodiment of the present disclosure;

FIG. 4 is a schematic cross-sectional view of a heat exchange tube of a heat exchanger according to an exemplary embodiment of the present disclosure;

FIG. 5 is a schematic structural diagram of a thermal management system according to an exemplary embodiment of the present disclosure;

FIG. 6 is a morphology of a sample according to some embodiments of the present disclosure before a salt spray test; and

FIG. 7 is a morphology of a sample according to some embodiments of the present disclosure after the salt spray test.

### DESCRIPTION OF EMBODIMENTS

For clear description of the objectives, technical solutions, and advantages of embodiments of the present disclosure, the technical solution of the present disclosure will be described clearly and completely below with reference to the embodiments of the present disclosure. It is obvious that the described embodiments are part, of the embodiments of the present disclosure, and do not represent all of the embodiments of the present disclosure. All other embodiments obtained by a person of ordinary skill in the art based on the technical solutions and the embodiments of the present disclosure without creative efforts shall fall within the scope of the present disclosure. Those without specific conditions in the examples are generally implemented under conventional conditions or conditions recommended by the manufacturers. The reagents or instruments used without specifying the manufacturers are all conventional products that can be purchased commercially.

The endpoints and any values of the ranges disclosed herein are not limited to the precise ranges or values in the present application, and these ranges or values should be understood to include values close to these ranges or values. For numerical ranges, the endpoint values of each range, the endpoint values of each range or individual point values, and the individual point values can be combined with each other to obtain one or more new numerical ranges.

It should be noted that the term “and/or” or “/” used herein refers only to an association relationship describing associated objects and indicates that there can be three relationships. For example, A and/or B can indicate three cases: only A exists, A and B exist at the same time, and only B exists. The singular forms “a”, “said” and “the” as used in embodiments of the present disclosure and the claims are also intended to include plural forms unless otherwise other meanings are explicitly indicated in the context.

In the description of the present disclosure, a list of items following the term “at least one of”, “at least a”, “at least one type of” or other similar terms may mean any combination of listed items. For example, if items A and B are listed, the phrase “at least one of A and B” means A only; B only; or A and B. In another example, if items A, B, and C are listed, the phrase “at least one of A, B, and C” means A only; B only; C only; or A and B (excluding C); A and C (excluding B); B and C (excluding A); or all of A, B, and C. Item A may include a single element or multiple elements. Item B may include a single element or multiple elements. Item C may include a single element or multiple elements. Furthermore, the terms “at least part”, “at least part of a surface”, or other similar terms are used to mean any part of the surface of the component or the entire surface of the component. For example, at least part of the surface of the heat exchanger refers to a certain part or parts by mass of the surface of the heat exchanger, or the entire surface of the heat exchanger.

In a specific embodiment, the present disclosure will be further described in detail below through specific embodiments.

In related technologies, micro-channel heat exchangers are highly efficient devices for heat exchange developed in the 1990s and can be widely used in chemical, energy and environmental fields. As compared with devices with conventional sizes, the micro-channel heat exchanger has many different characteristics, such as small size, light weight, high efficiency, high strength, and the like. Micro-channel technology has also triggered technological innovations in the fields of thermal management systems for new energy vehicles, household air conditioners, commercial air conditioners, and refrigeration devices to improve efficiency and reduce emissions.

In related technologies, while the application of all-aluminum micro-channel heat exchangers is gradually expanding, their promotion progress is relatively slow. The main technical bottlenecks include: the corrosion resistance of aluminum/aluminum alloy materials in the all-aluminum micro-channel heat exchanger is poor, and it is required to use the relevant corrosion-resistant coating technology to improve the corrosion resistance of the heat exchanger. However, there still exists defects in the corrosion-resistant technology commonly used in the related fields, which provide a chromium salt passivation coating layer or anodized electrophoretic coating. The corrosion-resistant coating technology for improving the corrosion resistance of the heat exchanger still needs to be improved. Therefore, how to improve the corrosion resistance of the heat exchanger to prolong the service life thereof has become an urgent problem to be solved in the industry.

Based on above description, the technical solutions of the embodiments of the present disclosure provide a heat exchanger capable of improving corrosion resistance and effectively slowing down frosting, a manufacturing method of the heat exchanger, and a thermal management system, which can improve the corrosion resistance and hydrophobicity of the coating material or coating layer in the related art, increase the service life of the heat exchanger and improve the heat exchange efficiency. The specific technical solutions are described as follows.

An embodiment of the present disclosure provides a heat exchanger. The heat exchanger includes a metal substrate, the metal substrate has a fluid channel for circulating a heat exchange medium. The heat exchanger further includes a coating layer. The coating layer includes a rare earth conversion coating layer and a hydrophobic coating layer. The rare earth conversion coating layer is relatively closer to a surface of the metal substrate. That is, the rare earth conversion coating layer and the hydrophobic coating layer may be sequentially laminated on at least part of an outer surface of the metal substrate of the heat exchanger. The rare earth conversion coating layer is bonded to the metal substrate by covalent bond, and the hydrophobic coating layer is bonded to the rare earth conversion coating layer by covalent bond. The hydrophobic coating layer is exposed to the environment.

In some embodiments, the outer surface of the metal substrate has an uneven rough surface, and a roughness of the rough surface is denoted as Ra, and 0.5 μm≤Ra≤10 μm. For example, the roughness of the rough surface is 0.5 μm, 1 μm, 2 μm, 3 μm, 4 μm, 5 μm, 6 μm, 7 μm, 8 μm, 9 μm, 10 μm and any value in a range formed by any tow of these point values. It can be understood that controlling the roughness of the outer surface of the metal substrate to fall within the above range is beneficial to the adhesion of the coating layer.

The heat exchanger can be used in a thermal management system such as an air conditioning system. The surface of the heat exchanger is provided with excellent hydrophobicity, which can enhance the efficiency of the heat exchanger to slow down frosting, improve heat exchange efficiency and corrosion resistance, and prolong the service life of the heat exchanger.

In some embodiments, the heat exchanger is a micro-channel heat exchanger.

For the convenience of description, a micro-channel heat exchanger is taken as an example of the above-mentioned heat exchanger in the embodiments of the present disclosure for specific illustration of the heat exchanger and manufacturing method thereof. However, those skilled in the art should understand that principles of the present disclosure or the arrangement of the rare earth conversion coating layer and the hydrophobic coating layer can be implemented in any heat exchanger arranged appropriately, and not limited to micro-channel heat exchangers. Furthermore, description of well-known functions and structures of the heat exchanger may be omitted for clarity and conciseness.

Referring to FIG. 1, according to an embodiment of the present disclosure, main structure of the heat exchanger 100 includes a header 10, a fin 13 and a plurality of heat exchange tubes 12. The heat exchange tubes 12 are fixed to a header 10. An inner cavity of the heat exchange tube 12 is in communication with an inner cavity of the header 10. The fin 13 is located between two adjacent heat exchange tubes 12. The heat exchanger 100 further includes a coating layer 11 which includes a rare earth conversion coating layer 101 and a hydrophobic coating layer 102. The rare earth conversion coating layer 101 is arranged on at least part of a surface of at least one of the header 10, the heat exchange tube 12 and the fin 13. The rare earth conversion coating layer 101 has a rare earth element-containing compound. The hydrophobic coating layer 102 is located on a side of the rare earth conversion coating layer 101 away from the header, the heat exchange tubes or the fin. For example, at least part of the surface of the rare earth conversion coating layer 101 is directly covered with a hydrophobic coating layer 102, and the hydrophobic coating layer 102 includes hydrophobically modified silica.

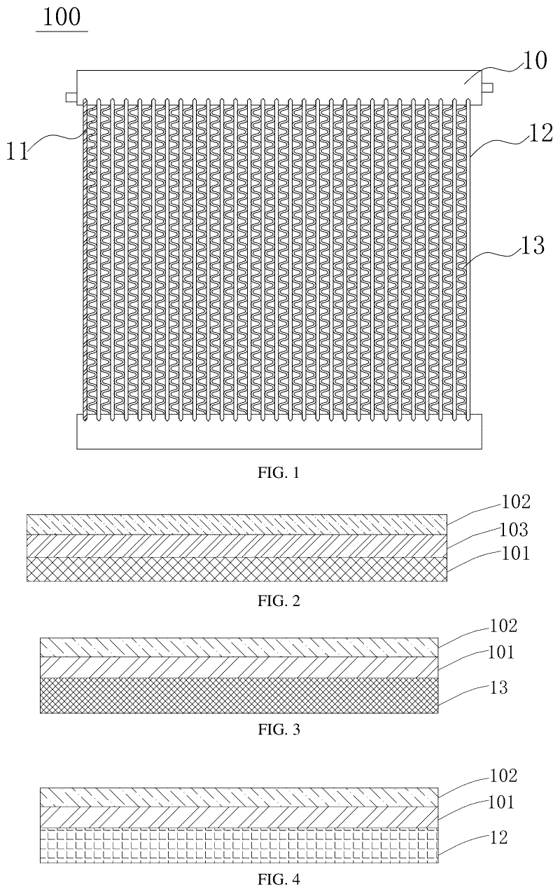

Certainly, in some other embodiments, as shown in FIG. 2, there may also exist a third coating layer 103 between the hydrophobic coating layer 102 and the rare earth conversion coating layer 101. The third coating layer 103 can be arranged on the rare earth conversion coating layer 101, and can also provide a coating basis for the hydrophobic coating layer 102. For example, the third coating layer 103 can be configured as a hydrophilic coating layer or other functional coating layers. That is, the surface of at least part of the structure of the heat exchanger is covered with the rare earth conversion coating layer 101, at least part of the surface of the rare earth conversion coating layer 101 is covered with the third coating layer 103, and at least part of the surface of the third coating layer 103 is covered with the hydrophobic coating layer 102.

In the heat exchanger 100 described above, at least part of the surface of at least one of the header 10, the heat exchange tube 12 and the fin 13 has the rare earth conversion coating layer and the hydrophobic coating layer 11. Particularly, at least part of the surface of at least one of the heat exchange tube 12 and the fin 13 is provided with the rare earth conversion coating layer, and at least part of the surface of the rare earth conversion coating layer is provided with the hydrophobic coating layer. For example, in FIG. 1, the coating layer 11 including the rare earth conversion coating layer 101 and the hydrophobic coating layer 102 are illustrated with reference to the shadow part on the surface of the leftmost heat exchange tube 12. Certainly, in other embodiments, the surface of other heat exchange tubes 12, fin 13, and/or a header 10 may all be covered with a rare earth conversion coating material and a hydrophobic coating material to form the rare earth conversion coating layer 101 and the hydrophobic coating layer 102.

In FIG. 1, two headers 10 are provided and arranged in parallel. A plurality of heat exchange tubes are arranged in parallel and connected with the two headers 10 for communicating the two headers. A width of the heat exchange tube 12 is greater than a thickness of the heat exchange tube 12, and a plurality of heat exchange channels extending along a length direction of the heat exchange tube 12 are formed inside the heat exchange tube 12. Therefore, the heat exchange tube 12 may be configured as a micro-channel flat pipe or an micro-channel elliptical pipe.

The plurality of heat exchange tubes 12 are arranged along an axial direction of the header 10, the fins 13 are corrugated along the length direction of the heat exchange tubes 12, and crests and troughs of the fins 13 are respectively connected to two adjacent heat exchange tubes 12. The arrangement of the fins 13 can increase the heat exchange area between the two adjacent heat exchange tubes, thereby improving the heat exchange efficiency of the heat exchanger. In some embodiments, a window structure may be provided in part of the area of the fin 13 to form a louvered fin to further enhance heat exchange.

It can be understood that the structure or the number of each component shown in FIG. 1 of the embodiment of the present disclosure does not constitute a specific limitation on the heat exchanger. In other embodiments of the present disclosure, the heat exchanger may include more or less components, or a different number or structure of the header, or a different number or structure of heat exchange tubes, or a different number or structure of the fin, or different component arrangements.

In some embodiments, the micro-channel heat exchanger is configured as an all-aluminum micro-channel heat exchanger. For example, the header, heat exchange tubes and the fin in the micro-channel heat exchanger are all made of materials containing aluminum or aluminum alloy. Connection relationships among the structure of the micro-channel heat exchanger and the various components belong to conventional knowledge in the art and will not be repeated herein.

Referring to FIG. 3, in some embodiments, at least part of the surface of the fin 13 is covered with the rare earth conversion coating layer 101, and at least part of the surface of the rare earth conversion coating layer 101 is covered with the hydrophobic coating layer 102.

In view of the structural characteristics of the micro-channel heat exchanger, temperature and humidity on the surface of the fin are the most important factors affecting the frosting of the heat exchanger. Generally, low temperature and uneven distribution of the temperature on the surface of the fin will cause uneven distribution of a frost layer and worsen the heat transfer of the heat exchanger, thus accelerating frosting. In addition, most of the micro-channel heat exchangers use the louvered fin, and the fin spacing is very small, which easily causes a “bridging” phenomenon between the condensed water droplets and reduces the drainage performance. The condensed water is accumulated at tips of the fin and is difficult to discharge. When the frost forms again, the condensed water freezes and the frosting phenomenon becomes worse after the second frosting cycle. Therefore, in the micro-channel heat exchanger, covering at least part of the surface of the fin with the rare earth conversion coating layer and the hydrophobic coating layer helps to improve the efficiency of slowing down frosting and improve the heat exchange effect.

Referring to FIG. 4, in some embodiments, at least part of the surface of the heat exchange tube 12 is covered with the rare earth conversion coating layer 101, and at least part of the surface of the rare earth conversion coating layer 101 is covered with the hydrophobic coating layer 102.

In some embodiments, at least part of the surface of the fin and at least part of the surface of the heat exchange tube are both covered with the rare earth conversion coating layer, and at least part of the surface of the rare earth conversion coating layer is covered with the hydrophobic coating layer.

In some embodiments, the rare earth conversion coating layer described above includes a rare earth element-containing compound, and the hydrophobic coating layer includes hydrophobically modified silica.

The heat exchanger according to the embodiment of the present disclosure is provided with the rare earth conversion coating layer and the hydrophobic coating layer, wherein the rare earth conversion coating layer includes the rare earth element-containing compound, and the hydrophobic coating layer includes hydrophobically modified silica. The rare earth conversion coating layer can be used as a primer coating arranged to cover to at least part of the surface of at least one of the header, the heat exchange tube and the fin. The hydrophobic coating layer can be used as a top coating arranged to cover to at least part of the surface of the rare earth conversion coating layer. Therefore, the heat exchanger can be firstly subjected to a rare earth conversion treatment to form a rare earth conversion coating layer, and then a sol-gel silane hydrophobic coating layer is used to perform hydrophobic surface treatment on the heat exchanger. The hydrophobic coating layer can be bonded to the surface of the heat exchanger subjected to rare earth conversion treatment through Si—O covalent bond, which is beneficial for tight bonding and good durability of the coating layer. Moreover, the use of the rare earth conversion coating layer can be used to further improve the compactness of the coating. When local pitting occurs, the rare earth conversion coating layer can block cathode reduction reaction, thereby improving the corrosion resistance of the heat exchanger. In addition, as the rare earth conversion coating layer is beneficial for corrosion resistance of the surface of the heat exchanger, it is not easy to generate metal corrosion oxides locally raised from the surface of the heat exchanger, which accordingly reduces destructive effect on the hydrophobic coating layer. The rare earth conversion coating layer in is conducive to maintain the durability of the hydrophobic coating layer. The hydrophobic coating layer with good hydrophobicity can be used to effectively reduce adhesion and enrichment of a corrosive solution, thereby avoiding the brittleness and hardness of the existing chromium salt passivation film, reducing the penetration of the corrosive media into the metal substrate, and further improving the corrosion resistance of the heat exchanger and effectively slowing down frosting on the surface of the heat exchanger. Therefore, through the synergistic cooperation of the rare earth conversion coating layer and the hydrophobic coating layer, the corrosion resistance of the heat exchanger can be improved to favorably prolong the service life of the heat exchanger. In addition, the surface of the heat exchanger has hydrophobicity, which can play a role in slowing down frosting. Furthermore, when the heat exchanger is used in an air conditioning system or a heat pump system, it is beneficial to prolong the service life and improve the heat exchange efficiency of the heat exchanger.

Tests have shown that the cost of the heat exchanger according to the embodiment of the present disclosure can be reduced through the arrangement of the rare earth conversion coating layer and the hydrophobic coating layer. Compared with the existing chromium salt passivation corrosion resistance treatment or anodized electrophoretic coating treatment, the solution of the present disclosure can be used to reduce the material process cost by at least 50%. The present disclosure further has the advantages of being green, the coating layer has good flexibility and can withstand the bending of the fin with low risk of cracking or delamination.

The specific type of the rare earth element-containing compound in the rare earth conversion coating layer can be varied in order to meet the requirements, such as, improving the corrosion resistance of heat exchanger, and so on. Specifically, in some embodiments, the rare earth elements in the rare earth element-containing compound include lanthanide rare earth elements, and the lanthanide rare earth elements include at least one of lanthanum, cerium, praseodymium, neodymium, promethium, samarium, and europium. For example, the rare earth element-containing compound may be a lanthanum-containing compound, a cerium-containing compound, a praseodymium-containing compound, a neodymium-containing compound, a promethium-containing compound, a samarium-containing compound, a europium-containing compound, or a mixture of any two or more of the above compounds in any ratio.

In addition, in other embodiments, the rare-earth element-containing compound is not limited to the examples listed above, and in the case where the requirements, such as, improving the corrosion resistance of the heat exchanger can be met, other types of the rare earth element-containing compound may also be used, which will not be described in detail herein.

In some embodiments, the rare earth element may be a cerium element, and the rare earth element-containing compound may be a cerium-containing compound. Specifically, in some embodiments, the rare earth element-containing compound includes an oxide of cerium (e.g., cerium oxide CeO₂) and a hydroxide of cerium (e.g., cerium hydroxide Ce(OH)₄). Considering extensive resources, accessibility or cost, a cerium-containing compound is selected as the rare earth element-containing compound, and the cerium-containing compound has a coexistence state of CeO₂ and Ce(OH)₄, in this case, the chemical properties thereof are stable, which is beneficial to improve the effect of anti-pitting corrosion, and can improve the corrosion resistance of the heat exchanger.

In some embodiments, the weight per unit area of the rare earth conversion coating layer can be controlled between 0.75 g/m² and 1.2 g/m². The average weight per unit area of the rare earth conversion coating layer may be not less than 0.75 g/m², and may further be greater than or equal to 0.75 g/m² and less than or equal to 1.2 g/m². In some embodiments, the weight per unit area of the hydrophobic coating layer is controlled between 4 g/m² and 10 g/m², and the average weight per unit area of the hydrophobic coating layer may not be less than 4 g/m², and may further be greater than or equal to 4 g/m², and less than or equal to 10 g/m². Appropriate thicknesses of the rare earth conversion coating layer and the hydrophobic coating layer is conducive to effectively improve the corrosion resistance of the heat exchanger and the efficiency of slowing down frosting, without adversely affecting the heat exchange efficiency of the heat exchanger.

In some embodiments, the present disclosure further provides a manufacturing method of a heat exchanger, wherein the heat exchanger can be the heat exchanger described in any of the above embodiments, and the manufacturing method includes the following steps:
(a) providing a metal substrate, a rare earth conversion coating material and a hydrophobic coating material, wherein the metal substrate has at least one fluid channel for circulating a heat exchange medium;
(b) applying the rare earth conversion coating material to at least part of a surface of the metal substrate, and curing the rare earth conversion coating material, to form a rare earth conversion layer, wherein the rare earth conversion coating material includes a rare earth element-containing compound; and
(c) applying the hydrophobic coating material to at least part of a surface of the rare earth conversion coating layer and curing the hydrophobic coating material, to obtain the heat exchanger.

It can be understood that during the preparation of the heat exchanger, the rare earth conversion coating material and the hydrophobic coating material can be obtained firstly and then sequentially arranged to cover to at least part of the surface of the metal substrate of the heat exchanger. Certainly, in the specific embodiments of the present disclosure, the sequence of preparation of the rare earth conversion coating material and the hydrophobic coating material is not limited. For example, the rare earth conversion coating material can be prepared firstly and then the hydrophobic coating material can be prepared, or the hydrophobic coating material can be prepared firstly and then the rare earth conversion coating material can be prepared, or the rare earth conversion coating material and the hydrophobic coating material can be prepared at the same time.

The preparation process of the heat exchanger is simple, easy to control, and highly feasible, and the reaction can be carried out easily under mild reaction conditions, causes less environmental pollution and has the advantages of being green. In addition, the preparation process is suitable for production in an industrial scale. The heat exchanger obtained by the manufacturing method can delay the frosting cycle, shorten the defrosting cycle, enhance the heat exchange efficiency, improve the corrosion resistance, and prolong the service life of the heat exchanger.

It should be understood that the manufacturing method of the heat exchanger and the aforementioned heat exchanger are based on the same application concept. For the specific structure of the heat exchanger, the composition of the coating layer or other related features, reference is made to the description of the aforementioned section about the heat exchanger, and it will not be repeated here.

In some embodiments, the rare earth conversion coating material comprises the following raw materials in parts by mass: 1 to 3 parts by mass of a rare earth raw material, 94 to 96 parts by mass of water, 1.5 to 4.5 parts by mass of an oxidant and 0 to 1 part by mass of an optional accelerator.

It should be noted that the above-mentioned “optional” accelerator means that the accelerator can be selectively added or not added, that is, the raw materials of the rare earth conversion coating material may include the accelerator or not. In some embodiments, the rare earth conversion coating material includes the following raw materials in parts by mass: 1 to 3 parts by mass of the rare earth raw material, 94 to 96 parts by mass of water, and 1.5 to 4.5 parts by mass of an oxidant. In other embodiments, the rare earth conversion coating material comprises the following raw materials in parts by mass: 1 to 3 parts by mass of a rare earth raw material, 94 to 96 parts by mass of water, 1.5 to 4.5 parts by mass of an oxidant, and 0 to 1 part by mass of an accelerator.

0 part by mass of the accelerator means that no accelerator is added. The accelerator can play a role in promoting the process of redox reaction on the surface of aluminum, for example, it can better turn Al into A13+ and electron e. Therefore, when the accelerator is added, the redox reaction on the aluminum surface can be accelerated, such that the reaction efficiency can be improved. However, when no accelerator is added, the redox reaction on the aluminum surface is relatively slow.

The rare earth conversion coating material is mainly prepared from appropriate dosages of a suitable rare earth raw material, water, oxidant and optional accelerator. When the rare earth conversion coating material is applied to an all-aluminum micro-channel heat exchanger, redox reaction can occur on the aluminum surface to generate a rare earth element-containing compound. In this way, at least part of the surface of the heat exchanger can exhibit good properties or structural stability to improve corrosion resistance.

Unless otherwise specified, the percentage, ratio or part involved herein are based on mass. “Part by mass” used here refers to a basic measurement unit of the mass ratio relationship of multiple components, and 1 part can represent any unit mass, for example, 1 part can be represented as 1 g, 1.68 g, 5 g, or the like.

In order to optimize the dosage of each component in the rare earth conversion coating material, improve the synergistic effect of the components, further improve the corrosion resistance and other properties of the coating material, and favorably improve the economic benefit of the coating material, in some embodiments, the rare earth conversion coating material includes the following raw materials in parts by mass: 1 to 3 parts by mass of a rare earth raw material, 95.1 parts by mass of water, 3 to 3.5 parts by mass of an oxidant, and 0.5 to 1 part by mass of an optional accelerator.

The above-mentioned rare earth raw material may be a raw material that contains a rare earth element, such as a raw material that can provide element cerium (Ce). In some embodiments, the rare earth raw material includes, but is not limited to, one of or a combination of at least two of cerium nitrate hexahydrate, anhydrous cerium nitrate, cerium chloride and polyhydrates thereof, cerium sulfate and polyhydrates thereof, cerium acetate and polyhydrates thereof. The above-mentioned cerium chloride and polyhydrates thereof refer to anhydrous cerium chloride, the polyhydrates of cerium chloride such as cerium chloride heptahydrate, cerium chloride octahydrate, or the like. Similarly, the above-mentioned cerium sulfate and polyhydrates thereof refer to anhydrous cerium sulfate and polyhydrates of cerium sulfate, such as cerium sulfate tetrahydrate; cerium acetate and polyhydrates thereof are anhydrous cerium acetate, polyhydrates of cerium acetate, such as cerium acetate trihydrate, cerium acetate tetrahydrate, or the like.

It should be understood that the rare earth element can be cerium element, and can also be lanthanum, praseodymium, neodymium, promethium, samarium, europium and other elements. When the rare earth element is lanthanum, praseodymium, neodymium and other elements, the rare earth raw material can be selected to have a compound that can provide the corresponding element.

In some embodiments, the oxidant includes, but is not limited to, at least one of hydrogen peroxide, sodium perchlorate, and t-butyl hydroperoxide. For example, the oxidant can be an aqueous solution of hydrogen peroxide (the mass concentration of hydrogen peroxide is about 27.5 wt. % to 30 wt. %), or the oxidant can be sodium perchlorate, or the oxidant can be an aqueous solution of tert-butyl hydroperoxide or a tert-butanol solution of tert-butyl hydroperoxide (the mass concentration of tert-butyl hydroperoxide is not less than 60 wt. %).

Based on the slight differences in the oxidizing properties or related performance of different oxidants, in practical applications, when different oxidants are used, the content of each oxidant can be adjusted appropriately. For example, when hydrogen peroxide is used as the oxidant, the dosage of hydrogen peroxide is 1.5 to 4.5 parts by mass; when tert-butyl hydroperoxide is used as the oxidant, the dosage of tert-butyl hydroperoxide is 1.2 to 3.6 parts by mass; when sodium chlorate is used as the oxidant, the dosage of sodium perchlorate is 1.5 to 4.5 parts by mass. The tert-butyl hydroperoxide has better oxidizing property and better application effect, so the dosage thereof can be appropriately reduced.

In some embodiments, the accelerator includes, but is not limited to, sodium chloride. Other types of accelerators can also be used as long as they can meet the requirement of promoting the redox reaction process on the aluminum surface.

In some embodiments, water can be deionized water.

Further, in some embodiments, the manufacturing method of the above-mentioned rare earth conversion coating material includes: dissolving 1 to 3 parts by mass of a rare earth raw material in 94 to 96 parts by mass of water to obtain a solution A; and heating the solution A to 45° C. to 55° C., and then adding 1.5 to 4.5 parts by mass of an oxidant to the solution A to obtain the rare earth conversion coating material.

In some embodiments, before the rare earth conversion coating material is obtained, the method further includes heating the solution A including the oxidant added to 30° C. to 55° C. That is, the manufacturing method of the above-mentioned rare earth conversion coating material includes: dissolving 1 to 3 parts by mass of a rare earth raw material in 94 to 96 parts by mass of water to obtain a solution A; heating the solution A to 45° C. to 55° C., and then adding 1.5 to 4.5 parts by mass of an oxidant to the solution A to obtain a solution B, and heating the solution B to 30° C. to 55° C. to obtain the rare earth conversion coating material. The film-forming effect of the rare earth conversion coating material is slightly different at different temperatures. The heating condition of heating the solution B to 30° C. to 55° C. is conducive to the reaction process of the rare earth element on the surface of the metal substrate, and is beneficial to film-forming of the rare earth conversion coating material and the combination of the film and the surface of the heat exchanger.

In some specific embodiments, the manufacturing method of the above-mentioned rare earth conversion coating material includes: mixing 1 to 3 parts by mass of a rare earth raw material, cerium nitrate hexahydrate, and 0.5 to 1 part by mass of an accelerator, sodium chloride, adding 95.1 parts by mass of deionized water, and performing mechanical stirring until the solid is completely dissolved to obtain a colorless and transparent solution A; heating the solution A in a water bath to 45° C. to 55° C., and then adding 1.5 to 4.5 parts by mass of an oxidant, an aqueous solution of hydrogen peroxide (27.5 wt. %), to the solution A to obtain a solution B; and further heating the solution B to 30° C. to 55° C. to obtain the rare earth conversion coating material.

Further, in the preparation process of the heat exchanger of the present disclosure, at least one of the header, the heat exchange tube and the fin is pretreated firstly, and then the prepared rare earth conversion coating material is coated to at least part of the surface of at least one of the header, the heat exchange tube and the fin, and then cured to form a rare earth conversion coating layer including a rare earth element-containing compound.

Specifically, in some embodiments, the surface of the heat exchange tube and/or the fin of the heat exchanger is pretreated. Specifically, the pretreatment step of the heat exchanger includes: sandblasting the surface of the heat exchange tube and/or the fin with a number of blasting meshes being 100 to 200 meshes, and then cleaning the surface of the heat exchange tube and/or fin with alcohol or acid, and then drying the surface at 35° C. to 50° C.

Further, during the pretreatment process, the number of blasting meshes in some embodiments is 120 to 180 meshes, for example, the number of blasting meshes is 150 meshes. The drying temperature is within a range of 35° C. to 50° C., and in some embodiments, the drying temperature is within a range of 38° C. to 45° C., for example, 40° C. The cleaning method used can be, for example, ultrasonic cleaning with anhydrous ethanol or acid etching.

In some embodiments of the present disclosure, the method of applying the rare earth conversion coating material to the pretreated surface of the heat exchanger includes, but not is limited to, at least one of dip coating, spray coating, brush coating, curtain coating and roller coating. Considering the convenience of implementation, the rare earth conversion coating material in the embodiments of the present disclosure can be applied to the pretreated surface of the heat exchange tube and/or the fin by spraying or dipping. For example, the pretreated heat exchanger can be immersed in the rare earth conversion coating material, and stand at 30° C. to 55° C. for 30 min to 50 min, such that the rare earth conversion coating material can undergo a redox reaction on the aluminum surface to form a rare earth conversion coating layer, and then the heat exchanger with the rare earth conversion coating layer is taken out and dried in the cold air or naturally. The equation involved in the oxidation reaction process of the rare earth conversion coating material on the aluminum surface can be expressed as follows:

Reaction on the Aluminum Surface:

anode (oxidation reaction): Al→Al³⁺+3e

Cathode (reduction reaction): O₂+2H₂O+4e→4OH⁻

H₂O₂+2e→2OH⁻

Ce³⁺+OH⁻+½H₂O₂→Ce(OH)₂²⁺

Ce(OH)₂²⁺+2OH⁻→Ce(OH)₄

Ce(OH)₄→CeO₂+2H₂O

As shown from the above, it can be concluded that the rare earth conversion coating layer includes a mixture of coexisting Ce(OH)₄ and CeO₂. In this way, the chemical properties are stable, which is conducive to improving the effect of anti-pitting corrosion, and can improve the corrosion resistance of heat exchanger.

Further, the above-mentioned hydrophobic coating material may be a modified hydrophobic silica sol. The hydrophobic coating material includes the following raw materials in parts by mass: 10 to 50 parts by mass of organosilane and/or siloxane, 45 to 89 parts by mass of a solvent, and 1 to 5 parts by mass of hydrophilic silica.

The hydrophobic coating material is mainly prepared from appropriate dosages of proper organosilane and/or siloxane, solvent and hydrophilic silica, wherein the organosilane and/or siloxane are hydrophobic materials, and they can exert their own basic properties such as high-temperature resistance, low-temperature resistance, oxidation stability, weather resistance, and low surface tension. Moreover, based on the excellent hydrophobicity of the organosilane and/or siloxane, the hydrophilic silica can be modified in the presence of a proper solvent such that the hydrophilic silica has a certain hydrophobicity. Therefore, in the hydrophobic coating material in the embodiments of the present disclosure, various properties are balanced through the synergistic effect of the above-mentioned specific contents of organosilanes and/or siloxanes, solvents and hydrophilic silica, to obtain modified hydrophobic silica sol with excellent performance such that the hydrophobic silica sol has better hydrophobicity.

When the above-mentioned hydrophobic coating material is applied to the heat exchanger, its hydrophobicity can effectively reduce the adhesion and enrichment of the corrosive solution, reduce the penetration of the corrosive media into the metal substrate, improve the corrosion resistance of the system, and can also provide at least part of the surface of the heat exchanger with hydrophobicity to slow down frosting. The hydrophobic surface can increase a contact angle between the water droplets formed at the initial stage of frosting and a wall surface of the heat exchanger, and reduce the contact area, and thus the water droplets get frozen slowly, which slows down the initial formation of frost crystals.

In the above hydrophobic coating material, the raw materials for its preparation may include organosilane or siloxane, or the raw materials may include both organosilane and siloxane. If the hydrophobically modified silica sol includes both the organosilane and the siloxane, there is no restriction on the ratio of organosilane to siloxane, and the total dosage of the organosilane and the siloxane is within the dosage range defined in the present disclosure, such as 10 to 50 parts by mass.

In order to further optimize the dosage of each component of the hydrophobically modified silica sol and improve the synergistic effect of the components, in some embodiments, the hydrophobic coating material includes the following raw materials by mass: 20 to 40 parts by mass of organosilane and/or siloxane, 50 to 80 parts by mass of a solvent, and 1 to 3 parts by mass of hydrophilic silica.

In the case of meeting the requirement for the hydrophobicity of the hydrophobic coating material or meeting the requirement for reducing the penetration of corrosive media and slowing down frosting, the specific type of the hydrophobic organosilane can be varied. Specifically, in some embodiments, the organosilane includes at least one of hexamethyldisilazane (HMDS), i.e., (CH₃)₃Si—NH—Si(CH₃)₃, methyltriethoxysilane (MTES), dimethyl diethoxysilane (DDS), trimethylchlorosilane (TMCS), dimethyldichlorosilane, and γ-glycidoxypropyltrimethoxysilane (KH-560). Exemplarily, the organosilane may be HMDS, MTES, DDS, TMCS, dimethyldichlorosilane or KH-560, or may be any mixture of two or more of HMDS, MTES, DDS, TMCS, dimethyldichlorosilane, and KH-560 in any ratio. In addition, in other embodiments, the organosilane is not limited to those enumerated above. In other embodiments, other types of organosilanes may also be used, such as monomethyltrichlorosilane and other similar chlorosilanes, will not be described one by one in detail here.

The use of HMDS, MTES, DDS, TMCS and other types of organosilanes is more helpful to improve the hydrophobicity of silica to prepare hydrophobic silica sols with better hydrophobicity.

In the case of meeting the requirement for the hydrophobicity of the hydrophobic coating material or meeting the requirement for reducing the penetration of corrosive media and slowing down frosting, the specific types of the solvent and the hydrophilic silica can be varied. Specifically, in some embodiments, the solvent includes alcohol solvents. Further, the alcohol solvents include alcohol solvents having 1 to 10 carbon atoms, preferably alcohol solvents having 1 to 8 carbon atoms, and more preferably alcohol solvents having 1 to 4 carbon atoms. Further, in some embodiments, the solvent is any one of methanol, ethanol, and isopropanol or a mixture of any two or more of methanol, ethanol, and isopropanol in any ratio.

The use of an alcohol solvent such as methanol, ethanol, isopropanol, and the like is helpful for the modification of hydrophilic silica by organosilane and/or siloxane, and the alcohol solvent is widely available, easy to obtain and low cost.

Specifically, in some embodiments, the hydrophilic silica includes at least one of fumed silica particles and dispersible silica sol.

Further, in some embodiments, the manufacturing method of the above-mentioned hydrophobic coating material includes: mixing 10 to 50 parts by mass of organosilane and/or siloxane, 45 to 89 parts by mass of a solvent and 1 to 5 parts by mass of hydrophilic silica together, and stirring at 30° C. to 45° C. with stirring speed being 200 to 500 rpm for a reaction for 15 to 45 min, to obtain the modified hydrophobic silica sol.

The hydrophobic coating material obtained by this manufacturing method can be used to form a hydrophobic surface that can slow down frosting and improve the condensed water discharge performance.

Exemplarily, the reaction equation involved in the above-mentioned preparation of the hydrophobic coating material is expressed as:

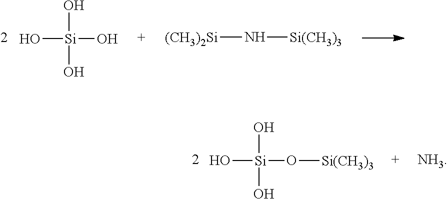

In some specific embodiments, the manufacturing method of the above-mentioned hydrophobic coating material includes: mixing 10 to 50 parts by mass of organosilane and/or siloxane, 45 to 89 parts by mass of a solvent and 1 to 5 parts by mass of hydrophilic silica together, and mechanically stirring at 35° C. to 40° C. in water bath with the stirring speed being 250 to 300 rpm for a reaction for 25 to 35 min, to obtain the modified hydrophobic silica sol.

In some embodiments of the present disclosure, the method of applying the hydrophobic coating material to the surface of the heat exchanger with the rare earth conversion coating layer includes, but is not limited to, at least one of dip coating, spray coating, brush coating, curtain coating and roller coating. Considering the convenience of implementation, the hydrophobic coating material according to the embodiment of the present disclosure can be applied to at least part of the surface of the rare earth conversion coating layer by spraying or dipping. For example, a hydrophobic coating material can be used to immerse the heat exchanger with the rare earth conversion coating layer, wherein the time of dip-coating is 2 to 5 min, and preferably 2 to 3 min; the dip-coating is carried out for 2 to 5 times, and preferably for 2 or 3 times.

In some embodiments, the hydrophobic coating material is applied to the surface of the rare earth conversion coating layer, and cured at 120° C. to 150° C., optionally 135° C. to 145° C., and further optionally 140° C., and the curing time is 0.5 h to 2 h, further optionally 0.8 h to 1.5 h, and further optionally 1 h.

By adopting the rare earth conversion coating layer and the hydrophobic coating layer of the present disclosure, and by further adjusting and optimizing the above preparation conditions of the heat exchanger, the heat exchanger with a corrosion-resistant coating layer and a super-hydrophobic anti-frost coating layer can be manufactured. The contact angle of the anti-frost coating is tested being greater than 150°, the anti-frost coating has good hydrophobicity and can be used to slow down the frosting behavior of the heat exchanger and reduce the penetration of corrosive media.

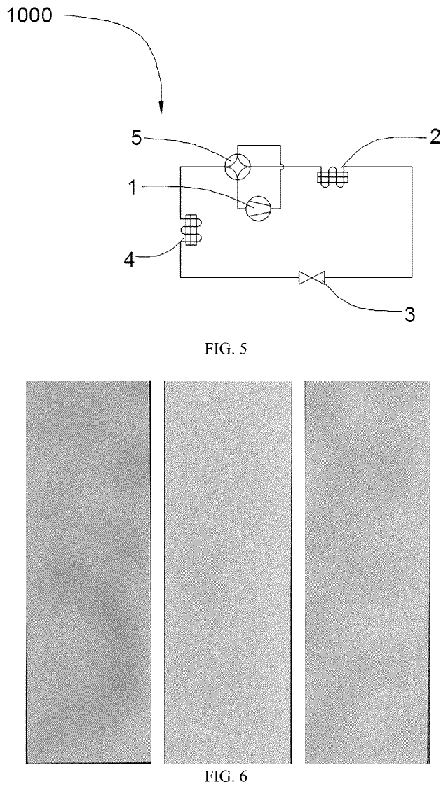

Embodiments of the present disclosure further provide a thermal management system, including the heat exchanger as described above. Specifically, as shown in FIG. 5, it is a thermal management system 1000 shown in an exemplary embodiment of the present disclosure. The thermal management system 1000 includes at least a compressor 1, a first heat exchanger 2, a throttling device 3, a second heat exchanger 4 and a reversing device 5. The compressor 1 of the thermal management system 1000 may be configured as a horizontal compressor or a vertical compressor. The throttling device 3 can be configured as an expansion valve, or the throttling device 3 is other components that have the effect of reducing the pressure and regulating the flow of a refrigerant. The present disclosure does not specifically limit the type of the throttling device, and the throttling device can be selected according to the actual application environment and will not be detailed here. It should be noted that, in some systems, the reversing device 5 may not be provided. The heat exchangers in the foregoing embodiments of the present disclosure may be used in the thermal management system 1000 as the first heat exchanger 2 and/or the second heat exchanger 4. In the thermal management system 1000, the compressor 1 compresses the refrigerant, the temperature of the compressed refrigerant increases, and then the compressed refrigerant enters into the first heat exchanger 2 where the refrigerant transfers the heat to the outside through the heat exchange between the first heat exchanger 2 and the outside; the refrigerant passes through the throttling device 3 where the refrigerant becomes a liquid or gas-liquid two-phase state with the temperature being decreased, and then the refrigerant with a relatively low temperature flows to the second heat exchanger 4 where the refrigerant exchanges heat with the outside, after that, the refrigerant with a lower temperature enters into the compressor 1 again, to achieve the circulation of the refrigerant.

In order to fully illustrate the properties for slowing down frosting and corrosion resistance of the heat exchanger according to the present disclosure so as to well understand the present disclosure, multiple tests have been carried out for verification in the present disclosure. The present disclosure will be further described below in conjunction with specific examples and comparative examples. Those skilled in the art will understand that the descriptions in the present disclosure are only part of examples, and any other suitable specific examples are within the scope of the present disclosure.

### Example 1

1. Preparation of the Coating Material

(a) Preparation of a rare earth conversion coating material: 1 part by mass of cerium nitrate hexahydrate and 0.6 part by mass of sodium chloride were mixed and then added to 95.1 parts by mass of deionized water for mechanical stirring until the solid was completely dissolved to obtain a colorless and transparent solution. The solution was then heated to 50° C. in a water bath, and 3.3 parts by mass of an aqueous solution of hydrogen peroxide (27.5 wt. %) was then added to the solution. The mixed solution was then heated to 50° C., to obtain the rare earth conversion coating material.

(b) Preparation of a hydrophobic coating material: 28 parts by mass of hexamethyldisilazane (HMDS), 71 parts by mass of ethanol and 1 part by mass of hydrophilic silica were mixed for mechanical stirring at 250 rpm to react for 30 min in a 35° C. water bath to obtain the hydrophobic coating material.

2. Manufacturing of the Heat Exchanger

(c) The surfaces of the heat exchange tubes and/or fin of the heat exchanger were pretreated. Specifically, the surfaces of the heat exchange tubes and/or fin of the heat exchanger were sandblasted with 150-mesh white corundum, and then cleaned with anhydrous ethanol, and then dried at 40° C.

(d) The surfaces of the heat exchange tubes and/or fin from step (c) were dip-coated and spray-coated with the rare earth conversion coating material obtained in step (a), and the heat exchange tubes and/or fin were then rested still at 50° C. for 40 min, and then taken out and cooled with the cold air to naturally, to obtain a heat exchanger with the rare earth conversion coating layer.

(e) The surface of the heat exchanger with the rare earth conversion coating layer from step (d) was dip-coated and spray-coated with the hydrophobic coating material obtained in step (b) and then cured at 140° C. for 1 h, to obtain a heat exchanger with the rare earth conversion coating layer and the hydrophobic coating layer.

### Example 2 to Example 6

The heat exchanger was prepared in the same manner as that in Example 1, except for the preparation of the rare earth conversion coating material.

In Example 2, the preparation of the rare earth conversion coating material was implemented as follows: 3 parts by mass of cerium nitrate hexahydrate and 1 part by mass of sodium chloride were mixed and then added to 96 parts by mass of deionized water for mechanical stirring until the solid was completely dissolved, to obtain a colorless and transparent solution. The solution was then heated to 55° C. in a water bath, and 3.5 parts by mass of an aqueous solution of hydrogen peroxide (27.5 wt. %) was then added to the solution. The mixed solution was then heated to 55° C. to obtain the rare earth conversion coating material.

In Example 3, the preparation of the rare earth conversion coating material was implemented as follows: 2 parts by mass of cerium nitrate hexahydrate and 0.8 part of sodium chloride were mixed and then added to 95.5 parts by mass of deionized water for mechanical stirring until the solid was completely dissolved, to obtain a colorless and transparent solution. The solution was then heated to 45° C. in a water bath, and 3.0 parts by mass of an aqueous solution of hydrogen peroxide (27.5 wt. %) was then added to the solution. The mixed solution was then heated to 45° C. to obtain the rare earth conversion coating material.

In Example 4, the preparation of the rare earth conversion coating material was implemented as follows: 1 parts by mass of cerium sulfate tetrahydrate and 0.7 part of sodium chloride were mixed and then added to 95.1 parts by mass of deionized water for mechanical stirring until the solid was completely dissolved to obtain a colorless and transparent solution. The solution was then heated to 50° C. in a water bath, and 2.5 parts by mass of an aqueous solution of tert-butyl hydroperoxide (65 wt. %) was then added to the solution. The mixed solution was then heated to 50° C. to obtain the rare earth conversion coating material.

In Example 5, the preparation of the rare earth conversion coating material was implemented as follows: 1.5 parts by mass of cerium chloride and 0.5 part of sodium chloride were mixed and then added to 95.5 parts by mass of deionized water for mechanical stirring until the solid was completely dissolved to obtain a colorless and transparent solution. The solution was then heated to 55° C. in a water bath, and 2 parts by mass of an aqueous solution of tert-butyl hydroperoxide (65 wt. %) was then added to the solution. The mixed solution was then heated to 55° C. to obtain the rare earth conversion coating material.

In Example 6, the preparation of the rare earth conversion coating material was implemented as follows: 1.5 parts by mass of cerium nitrate hexahydrate and 0.5 part of sodium chloride were mixed and then added to 95.1 parts by mass of deionized water for mechanical stirring until the solid was completely dissolved to obtain a colorless and transparent solution. The solution was then heated to 50° C. in a water bath, and 3.3 parts by mass of sodium perchlorate was then added to the solution. The mixed solution was then heated to 50° C. to obtain the rare earth conversion coating material.

The rest are the same as that in Example 1.

### Example 7 to Example 10

The heat exchanger was prepared in the same manner as Example 1, except for the preparation of the hydrophobic coating material.

In Example 7, the preparation of the hydrophobic coating material was implemented as follows: 15 parts by mass of HMDS, 52 parts by mass of ethanol and 1 part by mass of hydrophilic silica were mixed for mechanical stirring at 250 rpm to react for 30 min in a water bath at 35° C., to obtain the hydrophobic coating material.

In Example 8, the preparation of the hydrophobic coating material was implemented as follows: 50 parts by mass of HMDS, 89 parts by mass of ethanol and 5 parts by mass of hydrophilic silica were mixed for mechanical stirring at 250 rpm to react for 30 min in a water bath at 35° C., to obtain the hydrophobic coating material.

In Example 9, the preparation of the hydrophobic coating material was implemented as follows: 28 parts by mass of methyltriethoxysilane (MTES), 71 parts by mass of ethanol and 2 parts by mass of hydrophilic silica were mixed for mechanical stirring at 250 rpm to react for 25 min in a water bath at 40° C., to obtain the hydrophobic coating material.

In Example 10, the preparation of the hydrophobic coating material was implemented as follows: 28 parts by mass of trimethylchlorosilane (TMCS), 75 parts by mass of isopropyl alcohol and 1.5 parts by mass of hydrophilic silica were mixed for mechanical stirring at 250 rpm to react for 30 min in a water bath at 35° C., to obtain the hydrophobic coating material.

The rest are the same as that in Example 1.

### Example 11 to Example 12

The coatings material were prepared in the same manner as that in Example 1, except for the preparation of the heat exchanger.

In Example 11, in step (d), the surfaces of the heat exchange tubes and/or fin from step (c) were dip-coated and spray-coated with the rare earth conversion coating material obtained in step (a), and the heat exchange tubes and/or fin were then rested still at 55° C. for 30 min, and then taken out and dried with the cold air or dried naturally, to obtain a heat exchanger with the rare earth conversion coating layer.

In Example 12, in step (e), the surface of the heat exchanger with the rare earth conversion coating layer was coated thereon from step (d) was dip-coated and spray-coated with the hydrophobic coating material obtained in step (b) and the hydrophobic coating material was then cured at 135° C. for 1.5 h, to obtain a heat exchanger with the rare earth conversion coating layer and the hydrophobic coating layer.

The rest are the same as that in Example 1.

### Comparative Example 1

The difference between Comparative Example 1 and Example 1 is that no rare earth conversion coating layer or the hydrophobic coating layer are arranged in the heat exchanger in Comparative Example 1.

### Performance Test

In order to facilitate the property test, the test was carried out by means of a coated aluminum plate. That is, an aluminum plate made of the same material as the heat exchangers of the above examples and comparative example was used, and the above-mentioned rare earth conversion coating material and hydrophobic coating material were applied to the aluminum plate for testing. Specifically, the rare earth conversion coating material in Examples 1 to 12 were respectively applied to the pretreated surface of the aluminum plate, and then the hydrophobic coating material was applied to the surface of the rare earth conversion coating layer to obtain coated aluminum plate test samples of Test Examples 1 to 12 corresponding to Examples 1 to 12. Control Example 1 provides a blank aluminum plate, which is an aluminum plate not provided with a rare earth conversion coating layer or a hydrophobic coating layer.

Certainly, in other embodiments, the heat exchanger can be directly used for measurement. In this application, for the convenience of comparison, aluminum plates made of the same material are used for the comparison test. The test results are shown in Table 1 below. The test method is as follows.

### 1. Hydrophobicity Test (Contact Angle Test)

The test instrument used was a contact angle measuring instrument which measured the contact angle of a sample by an image profile analysis method based on the principle of optical imaging. The contact angle refers to an angle formed at a solid-liquid-gas three-phase junction on a solid surface when a liquid phase is sandwiched by two tangents of a gas-liquid interface and a solid-liquid interface after a liquid drop falls on a horizontal solid plane.

In the test, the contact angle measuring instrument and the computer connected to it were turned on, and testing software was operated.

A sample was placed on a horizontal workbench, the amount of a droplet was adjusted by using a micro-injector (the volume of the droplet is generally about 1 μl). A droplet was formed on the needle. The knob was then turned to move the workbench up such that the surface of the sample came into contact with the droplet. The workbench was then moved down, and then the droplet was left on the sample.

The contact angle of this area is obtained by testing and data analysis through the testing software. The sample of each of Embodiments and Comparative Examples was tested at 5 different points and an average value was taken and recorded as the contact angle of the sample of the Example and of the Comparative Example.

### 2. Corrosion Resistance Test (Salt Spray Test)

The heat exchanger samples prepared in Examples 1 to 12 and Comparative Example 1 were subjected to the salt spray test respectively. The acid salt spray test was carried out according to the test standard ASTM G85, and each sample was placed in a salt spray box, and taken out at regular intervals to observe the pitting on its surface. After a 216 h acid salt spray test, each sample was taken out to observe the pitting on its surface.

TABLE 1
Performance test results of test examples and control example

| | | Salt | Initial |
|---|---|---|---|
| | | spray | contact |
| Item | Salt spray test result | test time | angle |
| Test example 1 | Slight pitting on the surface | 216 h | >150° |
| Test example 2 | Slight pitting on the surface | 216 h | >150° |
| Test example 3 | Slight pitting on the surface | 216 h | >150° |
| Test example 4 | Slight pitting on the surface | 216 h | >150° |
| Test example 5 | Slight pitting on the surface | 216 h | >150° |
| Test example 6 | Localized pitting on the surface | 216 h | >150° |
| Test example 7 | Slight pitting on the surface | 216 h | >150° |
| Test example 8 | Slight pitting on the surface | 216 h | >150° |
| Test example 9 | Slight pitting on the surface | 216 h | >150° |
| Test example 10 | Localized pitting on the surface | 216 h | >150° |
| Test example 11 | Slight pitting on the surface | 24 h | >150° |
| Test example 12 | Slight pitting on the surface | 24 h | >150° |
| Control sample 1 | Intensive pitting on the surface | 24 h | <100° |

It can be seen from the data in Table 1 that the contact angles of the rare earth conversion coating layer and the hydrophobic coating layer of the heat exchanger according to the present disclosure are both greater than 150°, which increases the hydrophobicity. Excellent hydrophobicity of the surface of the heat exchanger can promote the condensed water discharge in a confined space. Moreover, most of the examples remained good surface morphology after acid salt spray test of more than 200 hours, only slight pitting occurs on the surface, which indicated excellent corrosion resistance that is beneficial to ensure the heat exchange performance and prolong the service life of the heat exchanger.

It should be noted that if the heat exchanger product is subjected to the corrosion resistance test, the following method can be used. After the heat exchanger is covered with the rare earth conversion coating layer and the hydrophilic coating, nitrogen is filled into the inner cavity of the heat exchanger until the pressure in the inner cavity achieves 1 MPa, then the inlet and outlet of the heat exchanger are sealed, and a connecting pipe is provided to connect a barometer. The heat exchanger is then put in the salt spray box for the salt spray test, and the pressure value change of the barometer is then observed. Pressure drop which indicates a certain part of the surface of the heat exchanger is corroded and perforated, is recorded as the failure of the heat exchanger. In practice, the corrosion resistance of the heat exchanger can be determined by the time it takes for the pressure to drop to a certain pressure.

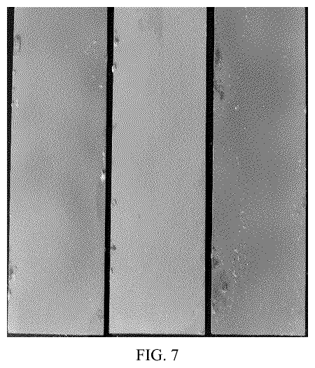

In addition, FIG. 6 shows morphologies of the samples of Example 1, Example 2 and Example 3 of the present disclosure (which correspond to Example 1, Example 2 and Example 3 successively from left to right) before the salt spray test. FIG. 7 shows morphologies of the samples of Example 1, Example 2 and Example 3 of the present disclosure (which correspond to Example 1, Example 2 and Example 3 successively from left to right) after the salt spray test. It can be seen from FIGS. 6 and 7 that the morphologies of the samples of Examples 1 to 3 remain relatively intact after acid salt spray test of 216 h, with only slight pitting on the surface, which indicates their good corrosion resistance.

In the description of the present disclosure, the description with reference to the terms “one embodiment”, “some embodiments”, “exemplary embodiment”, “example”, “specific example”, “some examples” or the like means specific features, structures, materials or characteristics described in connection with the embodiment or example are included in at least one embodiment or example of the present disclosure. In the present specification, the schematic representations of the above terms do not necessarily refer to the same embodiment. Moreover, the specific features, structures, materials, or characteristics described may be combined in a suitable manner in any one or more embodiments or examples. Directional words such as “upper”, “lower”, “inside”, “outer”, etc., used in embodiments of the present disclosure are used for description based on the accompanying drawings and should not be understood as a limitation on the embodiments of the present disclosure.

While the embodiments of the present disclosure have been shown and described, it will be understood by those skilled in the art that the various modifications, changes, substitutions and variations of the embodiments may be made without departing from the spirit and scope of the present disclosure. The scope of the present disclosure is defined by the appended claims and their equivalents.

What is claimed is:

1. A heat exchanger, comprising:
a metal substrate having a fluid channel for circulating a heat exchange medium; and
a coating layer comprising a rare earth conversion coating layer and a hydrophobic coating layer,
wherein the rare earth conversion coating layer is arranged to cover at least part of a surface of the metal substrate, the rare earth conversion coating layer comprises a rare earth element-containing compound, and at least part of the hydrophobic coating layer is further away from the metal substrate than the rare earth conversion coating layer.

2. The heat exchanger according to claim 1, wherein the rare earth conversion coating layer is connected to the metal substrate by a covalent bond; and
the hydrophobic coating layer is arranged to cover at least part of a surface of the rare earth conversion coating layer, and the hydrophobic coating layer is connected to the rare earth conversion coating layer by a covalent bond; and the hydrophobic coating layer is exposed to an environment.

3. The heat exchanger according to claim 1, wherein the hydrophobic coating layer comprises hydrophobically modified silica, and a static contact angle between the hydrophobic coating layer and water is greater than 150°.

4. The heat exchanger according to claim 1, wherein a rare earth element of the rare earth element-containing compound comprises at least one of lanthanum, cerium, praseodymium, neodymium, promethium, samarium and europium.

5. The heat exchanger according to claim 1, wherein the rare earth element-containing compound comprises an oxide of cerium and a hydroxide of cerium.

6. The heat exchanger according to claim 1, wherein the metal substrate comprises a header, a fin and a heat exchange tube, wherein the heat exchange tube is fixed to the header, and the fin is fixed to the heat exchange tube; and an inner cavity of the heat exchange tube is in communication with an inner cavity of the header; and
the coating layer is arranged to cover at least part of a surface of at least one of the header, the fin and the heat exchange tube.

7. The heat exchanger according to claim 6, wherein the metal substrate comprises two headers, a plurality of heat exchanger tubes and a plurality of fins;
the plurality of the heat exchanger tubes are arranged parallelly between the two headers along a length direction of the header, the heat exchange tube comprises a plurality of heat exchange channels extending along a length direction of the heat exchange tube, the inner cavity of the heat exchanger tube comprises the plurality of the heat exchanger channels, and the heat exchanger channel is in communication with the inner cavity of the header; and
the fin is corrugated along the length direction of the heat exchange tube, the fin is retained between two adjacent heat exchanger tubes, the fin has crests and troughs, and the fin is connected with the two adjacent heat exchanger tubes at the crests and the troughs.

8. The heat exchanger according to claim 6, wherein an outer surface of the metal substrate comprises an uneven rough surface, and a roughness of the rough surface is defined as Ra, and the Ra meets the following relation: 0.5 μm≤Ra≤10 μm; and
the coating layer is arranged to cover at least part of the rough surface.

9. The heat exchanger according to claim 1, wherein the coating layer further comprises at least one functional coating layer, and
at least part of the functional coating layer is sandwiched between the rare earth conversion coating layer and the hydrophobic coating layer.

10. The heat exchanger according to claim 1, wherein a weight per unit area of the rare earth conversion coating layer ranges from 0.75 g/m² to 1.2 g/m², and a weight per unit area of the hydrophobic coating layer ranges from 4 g/m² and 10 g/m².

11. A manufacturing method of a heat exchanger, comprising the following steps:
providing a metal substrate having at least one fluid channel for circulating a heat exchange medium;
forming a rare earth conversion coating layer on at least part of a surface of the metal substrate, wherein the rare earth conversion coating layer comprises a rare earth element-containing compound; and
forming a hydrophobic coating layer on at least part of a surface of the rare earth conversion coating layer.

12. The manufacturing method according to claim 11, wherein the forming a rare earth coating layer on at least part of a surface of the metal substrate comprises the following steps:
providing a rare earth conversion coating material, applying the rare earth conversion coating material to at least part of the surface of the metal substrate and curing the rare earth conversion coating material, to form the rare earth conversion coating layer, wherein the rare earth conversion coating material comprises the rare earth element-containing compound; and
forming a hydrophobic coating layer on at least part of a surface of the rare earth conversion coating layer comprises the following steps:
providing a hydrophobic coating material, applying the hydrophobic coating material to at least part of the surface of the rare earth conversion coating layer and curing the hydrophobic coating material, to form the hydrophobic coating layer.

13. The manufacturing method according to claim 12, wherein providing a rare earth conversion coating material comprises the following steps:
dissolving 1 to 3 parts by mass of a rare earth raw material in 94 to 96 parts by mass of water, to obtain a solution A;
heating the solution A to 45° C. to 55° C.; and
adding 1.5 to 4.5 parts by mass of an oxidant to the solution A, to obtain the rare earth conversion coating material.

14. The manufacturing method according to claim 13, wherein the rare earth conversion coating material has at least one of following features:
a) the rare earth raw material comprises at least one of cerium nitrate hexahydrate, anhydrous cerium nitrate, cerium chloride and polyhydrate thereof, cerium sulfate and polyhydrate thereof and cerium acetate and polyhydrate thereof;
b) the oxidant comprises 1.5 to 4.5 parts by mass of hydrogen peroxide; or 1.5 to 4.5 parts by mass of sodium perchlorate; or 1.2 to 3.6 parts by mass of tert-butyl hydroperoxide; and
c) the solution A further contains 0 to 1 parts by mass of an accelerator.

15. The manufacturing method according to claim 12, wherein providing a hydrophobic coating material comprises the following steps:
mixing 10 to 50 parts by mass of at least one of organosilane and siloxane, 45 to 89 parts by mass of a solvent and 1 to 5 parts by mass of hydrophilic silica together, and stirring at 30° C. to 45° C. for 15 to 45 min at a stirring speed of 200 to 500 rpm, to obtain a modified hydrophobic silica sol.

16. The manufacturing method according to claim 15, wherein the hydrophobic coating material comprises at least one of following features:
a) the organosilane comprises at least one of hexamethyldisilazane, methyltriethoxysilane, dimethyl diethoxysilane, trimethylchlorosilane, dimethyldichlorosilane, and γ-glycidoxypropyltrimethoxysilane;
b) the solvent comprises an alcohol solvent; and
c) the hydrophilic silica comprises at least one of fumed silica particles and dispersible silica sol.

17. The manufacturing method according to claim 12, wherein the applying the rare earth conversion coating material to at least part of a surface of the metal substrate and curing the rare earth conversion coating material comprises:
applying the rare earth conversion coating material to at least part of the surface of the metal substrate by at least one of dip coating, spray coating, brush coating, curtain coating and roller coating; and standing at 30° C. to 55° C. for 30 min to 50 min.

18. The manufacturing method according to claim 12, wherein the applying the hydrophobic coating material to at least part of a surface of the rare earth conversion coating layer and curing the hydrophobic coating material comprises:
applying the hydrophobic coating material to at least part of the surface of the rare earth conversion coating layer by at least one of dip coating, spray coating, brush coating, curtain coating or roller coating; and curing the hydrophobic coating material at 130° C. to 150° C. for 0.5 hours to 2 hours.

19. The manufacturing method according to claim 11, further comprising pretreating the metal substrate before the forming the rare earth conversion coating layer on at least part of a surface of the metal substrate, wherein pretreating the metal substrate comprises the following steps:
performing a sandblasting treatment of 100 to 200 meshes on at least part of the surface of the metal substrate, and then cleaning the metal substrate with alcohol or acid, and subsequently drying the metal substrate.

20. A thermal management system, comprising a compressor, a first heat exchanger, a throttling device, and a second heat exchanger;
wherein when a refrigerant flows in the thermal management system, the refrigerant flows into the first heat exchanger through the compressor, and then flows into the throttling device after exchanging heat in the first heat exchanger, and then flows into the second heat exchanger, and then flows into the compressor after exchanging heat in the second heat exchanger;
wherein at least one of the first heat exchange and the second heat exchanger is the heat exchanger according to claim 1.
